(19) United States
(12) Patent Application Publication
(10) Pub. No.: US 2005/0205548 A1
(43) Pub. Date: Sep. 22, 2005

(54) Integrated thin high temperature heaters

(76) Inventors: Tim Olding, Kingston (CA); Lars Johan Kallgren, Eden Prairie, MN (US); Mary Ruggiero, Toronto (CA)

Correspondence Address: Ralph A. Dowell of DOWELL & DOWELL P.C., 2111 Eisenhower Ave., Suite 406, Alexandria, VA, 22314, US

(21) Appl. No.: 10/997,997

(22) Filed: Nov. 29, 2004

Related U.S. Application Data
(60) Provisional application No. 60/540,627, filed on Jan. 29, 2004.

(51) Int. Cl. H05B 3/68

(52) U.S. Cl. 219/461.1

(57) ABSTRACT

This invention relates to integrated heaters for use in a wide range of consumer and industrial applications. The integrated heater capable of high temperature operation includes a substrate that is coated with a suitable electrically insulating coating, a resistive heating element which may be a foil, ribbon or wire, placed on top of the electrically insulating coating, and a high temperature insulation material which is used to affix the heating element up against the coated substrate by sandwiching the heating element between the coated substrate and the insulating material and keep the heating element in close contact with the coated substrate. The insulating layer is able to provide both electrical insulation and efficient thermal transfer. This resulting integrated heating element is able to meet the regulatory electrical insulation requirements and is capable of operation in excess of 600° C. The element can also survive being repeatedly thermally cycled between room temperature and the specified operating temperature.

### CROSS REFERENCE TO RELATED U.S. APPLICATION

This patent application relates to, and claims the priority benefit from, U.S. Provisional Patent Application Ser. No. 60/540,672 filed on Jan. 29, 2004, which is incorporated herein by reference in its entirety.

### FIELD OF THE INVENTION

This invention relates to integrated heaters for use in a wide range of consumer and industrial applications.

### BACKGROUND OF THE INVENTION

Integrated heaters, in which the heating element is directly attached or integrated with the material being heated, have long been sought after by the heating element industry. Many different approaches have been invented and developed over the years.

One approach to making a low profile integrated heater is to use a thick resistive film that is attached to the material to be heated. One of the early thick film products is a silver/glass based formulation that has enabled the design of unique products such as fast boiling water kettles. However the cost of the silver materials and the processing requirements limit the utility of these materials. One of current authors recently developed an alternative thick film technology based on graphite powder dispersed in a sol gel matrix. This approach is extremely versatile and cost effective, but is limited in its temperature of operation to below 400° C.

Another approach to making a low profile integrated heater has been to use a thin foil of stainless steel or some other material that has been etched into a pattern so as to deliver the required power and heat distribution. These foil materials are capable of operating at high temperatures without any change in performance. These foils can be attached to a variety of materials using inorganic cements. However, simply attaching a foil to another material in general does not result in a viable high temperature, heating element. In order to make a viable element the foil needs to be electrically isolated from the material to which it is being attached. Obviously it cannot be attached directly to metal or it would short out. Alternatively, the resistive foil cannot be in direct contact with glass because most glasses become conductive at high temperatures. Any electrically insulating layer should not greatly retard the thermal transfer of the heat from the foil to the substrate material.

One application for which this type of element would be ideal is an integrated glass ceramic cook top. There have been many attempts to make this type of design using either a thick film approach or using an etched foil heating element that is fixed to the glass ceramic with cement. However, these designs do not meet the industry acceptance tests due to the fact that the glass ceramic becomes conductive at 200° C. Fixing an element in direct contact with the glass ceramic results in a unit that does not meet the regulatory standards for electrical safety.

### SUMMARY OF THE INVENTION

This invention is an integrated thin heater design has been designed with a suitable electrically insulating layer to separate the thin heating element from the conductive substrate material. This insulating layer is able to provide both electrical insulation and efficient thermal transfer.

This resulting integrated heater is able to meet the regulatory electrical insulation requirements and is capable of operation in excess of 600° C. The heating element can also survive being repeatedly thermally cycled between room temperature and the specified operating temperature.

In one aspect of the invention there is provided a heater capable of high temperature operation comprising:

a substrate that is coated with a suitable electrically insulating coating;

a resistive heating element which is one of a foil, ribbon or wire, placed on top of the electrically insulating coating; and

a high temperature insulating material which is used to affix the heating element up against the coated substrate by sandwiching the heating element between the coated substrate and the insulating material to keep the heating element in close contact with the coated substrate.

The heating element may be attached to a high temperature backing material using an adhesive. The substrate may be made of glass, glass-ceramic, ceramic, metal, anodized aluminum or porcelainized metal. The electrically insulating coating may be a sol gel composite.

In another aspect of the invention there is provided an integrated glass ceramic heating element capable of high temperature operation comprising:

a glass ceramic substrate coated with at least 400 microns of sol gel composite alumina/silica layer;

a resistive heating element which is made by etching a metal foil and is placed on top of the sol gel composite alumina/silica layer; and

a high temperature insulating material which is used to affix the heating element up against the coated substrate by sandwiching the heating element between the coated substrate and the insulating material to keep the heating element in close contact with the coated substrate.

The present invention also provides an integrated glass ceramic heating element capable of high temperature operation comprising:

a glass ceramic substrate coated with at least 400 microns of sol gel composite alumina/silica layer;

a resistive heating element which is made by etching a metal foil and is placed on top of the sol gel composite alumina/silica layer;

mechanical coupling means for pressing the etched foil resistive heating element so that it is in direct contact with the sol gel composite alumina/silica layer coated glass ceramic substrate.

Further features and advantages of the present invention, as well as the structure and operation of various embodiments of the present invention, are described below in detail.

### BRIEF DESCRIPTION OF DRAWINGS

The following is a description, by way of example only, of the constructed in accordance with the present invention, reference being had to the accompanying drawings;

FIG. 1 shows a cross section of a part of an integrated heater including a high temperature glass ceramic cooktop element fabricated by depositing 500 micrometers of sol gel composite alumina-silica onto zero expansion LAS glass ceramic;

FIG. 2 shows a cross section of an integrated heater using an etched foil fixed to a backing material and placed up against a sol gel composite dielectric coated glass ceramic with the element facing so that it is in direct contact with the dielectric layer, and a thermally insulating cement is used to attach the system together;

FIG. 3 shows a cross section of an alternative embodiment of an integrated heating element;

FIG. 4 shows a cross section of another alternative embodiment of an integrated heating element heater; and

FIG. 5 shows a meander pattern resistive heating element with a circular envelope used in the integrated heater of FIG. 2.

### DETAILED DESCRIPTION OF THE INVENTION

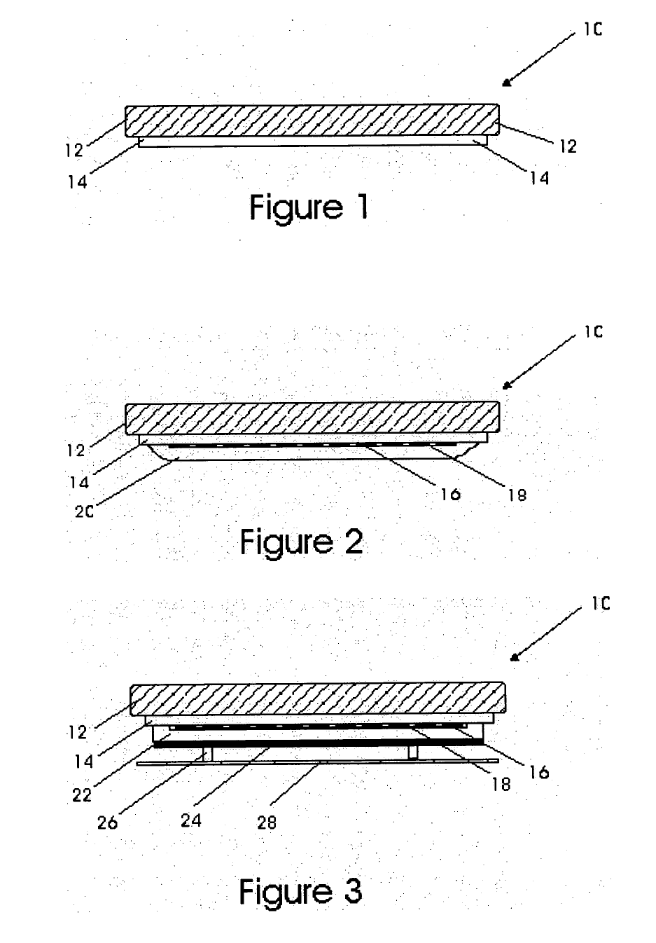

An integrated heater constructed in accordance with the present invention for use in a wide range of consumer and industrial applications, is shown generally at 10 in FIG. 2. Referring to FIGS. 1 and 2, the integrated heater 10 is made up of a base material 12 coated with a suitable electrically insulating layer 14, and a thin resistive heating element 16 (FIG. 2) fixed to a backing material 18 (FIG. 2) and placed in mechanical contact with the base material 12 coated with the electrically insulating layer 14. These components, base material 12, electrically insulating layer 14, thin resistive heating element 16, and backing material 18 are all bonded or mechanically fixed together to form a completely integrated high temperature heater 10. The heating element 16 may be bonded using a high temperature cement 20 which can be one of a wide range of low to medium density refractories. In particular, low density insulating aluminosilicate-based castable refractories are well suited for this application.

The base substrate 12 can be one of glass, glass-ceramic, ceramic, metal, anodized aluminum or porcelainized metal. The electrically insulating layer 14 can be one of sol gel composite ceramic, high temperature electrically insulating dielectric glaze, anodizing, thermal or a plasma spray ceramic coating. The resistive heating element 16 can be etched, cut or stamped foil made from metal resistance alloys such as steel, stainless steel, iron-nickel-chromium alloys such as Inconel, nickel-chromium alloys, iron-chromium-aluminum alloys, or other high temperature resistance alloys. The resistive heating element 16 can also be a ribbon or wire. The resistive heating element 16 can be attached to a high temperature backing material 18 for structural support during the etching process and subsequent placement against the coated base material. This backing material 18 can be one of ceramic paper, ceramic cloth, ceramic board, mica paper, mica board, fiberglass paper, fiberglass cloth or fiberglass blanket or calcium silicate board.

The etched foil resistive heating element 16, which may or may not be attached to a backing material 18, can be fixed to the layer 14 on the base substrate 12 by the high temperature cement 20 as in FIG. 2, or it can be mechanically pressed up against layer 14 on base substrate 12 using a high temperature insulation material 22 as in FIG. 3, where the insulation material 22 is backed by a base plate 24 and pressure contacts 26 connected to a mounting frame 28. High temperature insulation 22 may be the same as the high temperature cement 20, or it can be any non-conductive material, but is preferably a lightweight, thermal insulation board such as ceramic fiberboard, calcium silicate board, mineral wool board microporous silica, or vermiculite board.

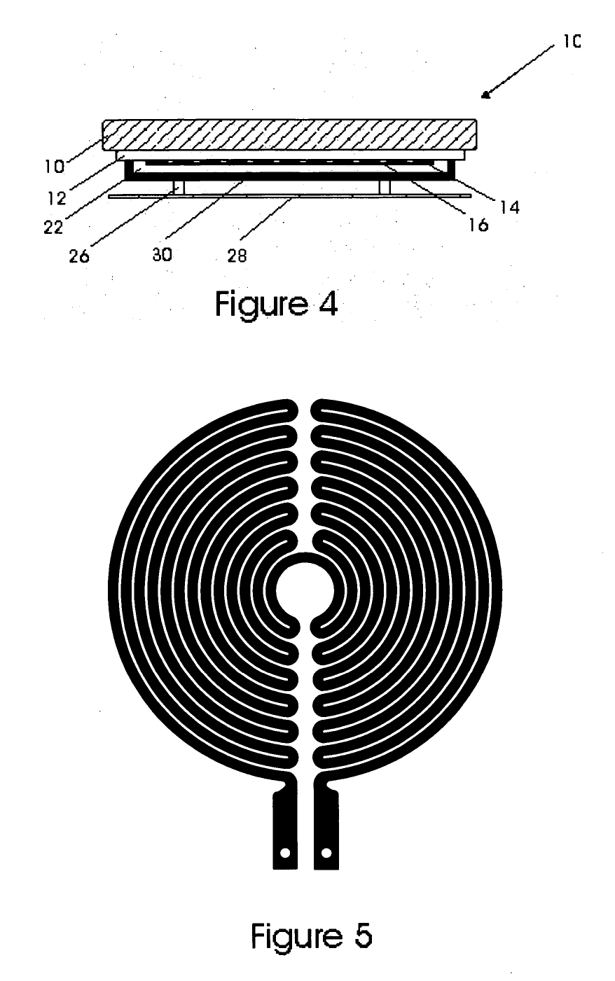

Alternatively, referring to FIG. 4, a high temperature thermal insulation material 22 can be pressed into a metal dish support 30. The etched foil resistive heating element 16 may then be mechanically pressed up against layer 14 on base substrate 12 using the metal dish support 30 containing the pressed thermal insulation layer 22 as in FIG. 4, where the metal dish support 30 is backed by pressure contacts 26 connected to mounting frame 28. The metal can backing plate or support dish 30 has a receptacle in the top surface which contains the high temperature thermally insulation layer 22 and an etched foil/mica paper combination resistive heating element 16 and backing material 18 to which element 16 is affixed. This component is placed up against the glass ceramic substrate 12 coated with the a sol gel composite layer 14 with the element 16 facing so that it is in direct contact with the dielectric layer. The mounting frame with pressure contacts such as springs transferring pressure against the backing plate with springs is used to provide adequate pressure to hold the entire system in place and ensure that the etched foil resistive heating element remains in direct contact with the sol gel composite dielectric coated glass ceramic.

The high temperature insulation material 22 may be made of the same material as high temperature cement 20, or it can be any non-conductive material, but is preferably a lightweight, thermal insulation board such as ceramic fiberboard, calcium silicate board, mineral wool board microporous silica, or vermiculite board.

### EXAMPLE 1

A high temperature glass ceramic cooktop such as shown at 10 in FIG. 2 was fabricated by forming the electrically insulating layer 14 on base substrate 12 by depositing 500 micrometers of sol gel composite alumina-silica, to form layer 14, onto zero expansion lithium aluminosilicate (LAS) glass ceramic base 12 as shown in FIG. 1. An etched foil resistive heating element 16 (FIG. 2) was made by attaching a 25 micrometer thick sheet of 304 stainless steel to 75 micrometers thick Firox™ mica paper backing material 18, using a silicone adhesive. Using a stainless steel etching solution, a meander pattern element with a circular envelope was produced as shown in FIG. 5. This etched foil 16 backed by mica paper 18 was placed on top of the dielectric coated 14 glass ceramic base 12 with the element 16 facing down so that it was in direct contact with the dielectric layer. The element 16 was then fixed in place using a high temperature aluminosilicate cement 20 as shown in FIG. 2. The cement was left to dry for several hours and then the element was ready for operation.

This unit passes the high pot standard for glass ceramic cook tops and operates stably up to an element temperature of 600° C.

### EXAMPLE 2

A high temperature glass cooktop was fabricated by depositing 500 micrometers of sol gel composite alumina/silica of sol gel composite alumina-silica onto zero expansion LAS glass ceramic. An etched foil was made by attaching a 25 micrometers thick sheet of 304 stainless steel to 75 micrometers thick Firox™ mica paper using a silicone adhesive. Using a stainless steel etching solution, a meander pattern element with a circular envelope was produced. This etched foil backed by mica paper was sandwiched between the dielectric coated glass ceramic, and a ¼ inch disk of lightweight, thermally insulating vermiculite board 22. The entire unit was then placed inside a fixture in which a pressure plate 24 backed by springs 26 connected to a mounting frame 28 were used to keep the vermiculite firmly affixed against the dielectric coated glass ceramic as shown in FIG. 3.

This unit passes the high pot standard for glass ceramic cook tops and operates stably up to element temperatures in excess of 600° C. This surface temperature of the glass is typically 50-100 degrees Centigrade lower than the element temperature. This unit can be controlled with a standard energy regulator and a simple bimetallic switch placed in the middle of the foil provides protection against thermal runaway.

### EXAMPLE 3

A glass cooktop is made according to the design described in Example 2, except that the vermiculite disk is fixed to the dielectric coated glass ceramics by using silicone to attach the vermiculite around periphery of the disk, where the temperature is cooler.

### EXAMPLE 4

A high temperature glass cooktop is made using a two component system. One component consists of coating 500 microns of sol gel composite alumina/silica onto zero expansion LAS glass ceramic. A second component was made by: 1) fabricating an etched foil resistive heating element according the process in Example 1, 2), pressing a high temperature thermal insulation material 22 into a thin metal dish 30 with a diameter slightly larger than the diameter of the etched foil, and so that the insulation material filled the entire dish. The etched foil resistive heating element was placed on top of the dish filled with the thermally insulation material. The second component was then pressed up against the first component (the dielectric coated glass) and held in place using the springs and backing plate mounting frame used in Example 3.

### EXAMPLE 5

A metal based integrated heating element is made by depositing 250 microns of sol gel composite alumina/silica onto a plate of 304 stainless steel. An etched foil was made by attaching a 25 micron thick sheet of 304 stainless steel to a 75 microns thick Firox™ mica paper using a silicone adhesive. Using a stainless steel etching solution, a meander pattern element with a circular envelope was produced. The etched foil-backed by mica paper was sandwiched between the dielectric coated stainless steel plate and a ¼ inch disk of lightweight, thermally insulating vermiculite board. This entire unit was placed in a fixture so as to keep the vermiculite firmly affixed against the dielectric coated stainless steel plate. This unit operates stably to temperatures in excess of 300° C.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. An integrated heater capable of high temperature operation comprising:
a substrate that is coated with a suitable electrically insulating coating;
a resistive heating element which is one of a foil, ribbon or wire, placed on top of the electrically insulating coating; and
a high temperature insulating material which is used to affix the heating element up against the coated substrate by sandwiching the heating element between the coated substrate and the insulating material to keep the heating element in close contact with the coated substrate.

2. A heater according to claim 1 wherein the substrate 12 is made of one of glass, glass-ceramic, ceramic, metal, anodized aluminum or porcelainized metal.

3. A heater according to claim 1 wherein the electrically insulating coating is a sol gel composite, and wherein the glass ceramic substrate is a lithium aluminosilicate (LAS) glass ceramic.

4. A heater according to claim 1 wherein the electrically insulating coating is one of a high temperature dielectric glaze, a plasma spray, a thermal spray and a ceramic coating.

5. A heater according to claim 1 wherein the resistive heating element is made of a metal resistance alloy, said metal resistance alloy being one of stainless steel, steel, iron-nickel-chromium, nickel-chromium or iron-chromium-aluminum alloy.

6. A heater according to claim 1 wherein the etched foil is attached to a high temperature backing material using an adhesive.

7. A heater according to claim 6 wherein the high temperature backing layer is one of ceramic cloth, ceramic paper, ceramic board, mica paper, mica board, millboard, fiberglass paper, fiberglass cloth, fiberglass blanket or calcium silicate board.

8. A heater according to claim 6 wherein the adhesive is an inorganic-based adhesive.

9. A heater according to claim 6 wherein the adhesive is an organic-based adhesive.

10. A heater according to claim 1 wherein the high temperature insulating material is a high temperature cement.

11. A heater according to claim 10 wherein the high temperature cement is a low density insulating aluminosilicate-based castable refractory.

12. A heater according to claim 1 wherein the high temperature insulating material is a high temperature resistant, non-conductive material which is mechanically pressed against the heating element 16 so as to hold it in close contact with the dielectric coated glass.

13. A heating according to claim 12 wherein the high temperature resistant, non-conductive material is a lightweight, thermally insulating material such as ceramic fiberboard, calcium silicate board, mineral wool board, microporous silica, or vermiculite board.

14. A heater according to claim 3 wherein the sol gel composite is an alumina-silica sol gel composite.

15. An integrated glass ceramic heating element capable of high temperature operation comprising:
a glass ceramic substrate coated with at least 400 microns of sol gel composite alumina/silica layer;
a resistive heating element which is made by etching a metal foil and is placed on top of the sol gel composite alumina/silica layer; and
a high temperature insulating material which is used to affix the heating element up against the coated substrate by sandwiching the heating element between the coated substrate and the insulating material to keep the heating element in close contact with the coated substrate.

16. A heater according to claim 15 wherein the glass ceramic substrate is a lithium aluminosilicate (LAS) glass ceramic.

17. A heater according to claim 15 wherein the etched metal foil is made of metal resistance alloys such as stainless steel, steel, iron-nickel-chromium, nickel-chromium or iron-chromium-aluminum alloy.

18. A heater according to claim 15 wherein the etched metal foil is attached to a high temperature backing material using an adhesive.

19. A heater according to claim 18 wherein the high temperature backing layer is any one of ceramic cloth, ceramic paper, ceramic board, mica paper, mica board, millboard, fiberglass paper, fiberglass cloth, fiberglass blanket or calcium silicate board.

20. A heater according to claim 18 wherein the adhesive may be an inorganic.

21. A heater according to claim 18 wherein the adhesive may be organic.

22. A heater according to claim 15 wherein the high temperature insulating material is a high temperature cement material.

23. A heater according to claim 22 wherein the high temperature cement is a low density insulating aluminosilicate-based castable refractory.

24. A heater according to claim 15 wherein the high temperature insulating material is a high temperature, non-conductive ceramic material which is mechanically pressed against the heating element so as to hold it in close contact with the dielectric coated glass.

25. A heating according to claim 24 wherein the non-conductive ceramic material is a lightweight, thermally insulating material being any one of ceramic fiberboard, calcium silicate board, mineral wool board, microporous silica, or vermiculite board.

26. A heating according to claim 24 wherein the high temperature insulating material is mechanically pressed against the heating element using a mechanical coupling means which includes a high temperature insulation material which contacts the etched foil resistive heating element, and a base plate which backs said high temperature insulation material.

27. A heating according to claim 26 wherein the mechanical coupling means includes a mounting frame having pressure contacts attached thereto which bear against the base plate.

28. An integrated glass ceramic heating element capable of high temperature operation comprising:
a glass ceramic substrate coated with at least 400 microns of sol gel composite alumina/silica layer;
a resistive heating element which is made by etching a metal foil and is placed on top of the sol gel composite alumina/silica layer;
mechanical coupling means for pressing the etched foil resistive heating element so that it is in direct contact with the sol gel composite alumina/silica layer coated glass ceramic substrate.

29. A heating according to claim 28 wherein the mechanical coupling means includes a high temperature insulation material which contacts the etched foil resistive heating element, and a base plate which backs said high temperature insulation material.

30. A heating according to claim 29 wherein the mechanical coupling means includes a mounting frame having pressure contacts attached thereto which bear against the base plate.

31. A heating according to claim 28 wherein the mechanical coupling means includes a high temperature insulation material which contacts the etched foil resistive heating element, and a metal dish support which holds said high temperature insulation material in a receptacle in a top surface of the metal dish support.

32. A heating according to claim 31 wherein the mechanical coupling means includes a mounting frame having pressure contacts attached thereto which bear against the a bottom surface of the metal dish support.

33. A heater according to claim 29 wherein the etched metal foil is made of a metal resistance alloy, said metal resistance alloy being any one of stainless steel, steel, iron-nickel-chromium, nickel-chromium or iron-chromium-aluminum alloy.

34. A heater according to claim 28 wherein the etched metal foil is attached to a high temperature backing material using an adhesive.

35. A heater according to claim 34 wherein the high temperature backing layer is any one of ceramic cloth, ceramic paper, ceramic board, mica paper, mica board, millboard, fiberglass paper, fiberglass cloth, fiberglass blanket or calcium silicate board.

36. A heater according to claim 34 wherein the adhesive is an inorganic-based adhesive.

37. A heater according to claim 34 wherein the adhesive is an organic-based adhesive.

38. A heater according to claim 28 wherein the glass ceramic substrate is a lithium aluminosilicate (LAS) glass ceramic.
